(19) United States
(12) Patent Application Publication
(10) Pub. No.: US 2026/0303516 A1
(43) Pub. Date: Oct. 1, 2026

(54) DETERMINISTIC DATA CENTER FORWARDING IN AI TRAINING CLUSTERS

(71) Applicant: Cisco Technology, Inc., San Jose, CA (US)

(72) Inventors: Pablo CAMARILLO GARVÍA, Madrid (ES); Clarence FILSFILS, Brussels (BE)

(21) Appl. No.: 19/093,696

(22) Filed: Mar. 28, 2025

(51) Int. Cl. H04L 45/24; H04L 43/062

(52) U.S. Cl. CPC H04L 45/24; H04L 43/062

(57) ABSTRACT

In one embodiment, a method includes associating, by a router, each bin of a plurality of bins with one or more source port values, wherein each bin corresponds to an equal-cost multipath route from the router within a data center and receiving, by the router, a particular packet from a processing unit in the data center, the particular packet having a source port as selected by the processing unit to correspond to a particular selected bin of the plurality of bins. The method further includes encapsulating, by the router, the particular packet with a deterministic path header associated with a particular equal-cost multipath route corresponding to the particular selected bin and transmitting, by the router, the particular packet within the data center via the particular equal-cost multipath route.

### TECHNICAL FIELD

The present disclosure relates generally to computer networks, and, more particularly, to deterministic data center forwarding in artificial intelligence (AI) training clusters.

### BACKGROUND

The proliferation of Artificial Intelligence (AI) and machine learning (ML) applications can necessitate advanced training clusters that can efficiently handle the massive computational demands of these technologies. A critical component of these clusters is the synchronization process among Graphics Processing Units (GPUs), which exhibits a unique traffic pattern distinct from conventional Data Center (DC) networking paradigms. Traditional DC networks are characterized by numerous asynchronous, small-bandwidth, and short-lived flows, supplemented by a few larger, asynchronous, long-lived flows primarily for storage purposes. In contrast, AI training clusters exhibit synchronous, bursty, low-entropy, high-bandwidth, and long-lived traffic flows. This discrepancy can result in the rapid saturation of links, often within microseconds, leading to tail-latency issues that can significantly affect the completion time of GPU-based training tasks.

Some approaches attempt to address these challenges using Distributed Scheduled Fabric (DSF) and/or Dynamic Load Balancing (DLB) techniques. Further, techniques such as “spraying,” which involves distributing traffic across multiple links to mitigate congestion, have shown promise but lack a standardized implementation. Other proposals range from methodologies of dividing packets into smaller 64B cells to straightforward traffic dispersal without packet segmentation techniques. Alternatively, some approaches have sought to combine packet entropy with DLB (Dynamic Load Balancing; Flowlet based steering) as an attempt to navigate the limitations of DSFs, offering a reduction in bandwidth costs and operational complexity.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example data center in accordance with the disclosure;

FIG. 4 illustrates an example flow for deterministic data center forwarding in artificial intelligence (AI) training clusters;

FIG. 5 illustrates an example procedure for deterministic data center forwarding in artificial intelligence (AI) training clusters; and

FIG. 6 illustrates another example procedure for deterministic data center forwarding in artificial intelligence (AI) training clusters.

### DESCRIPTION OF EXAMPLE EMBODIMENTS

### Overview

According to one or more embodiments of the disclosure, a method includes associating, by a router, each bin of a plurality of bins with one or more source port values, wherein each bin corresponds to an equal-cost multipath route from the router within a data center and receiving, by the router, a particular packet from a processing unit in the data center, the particular packet having a source port as selected by the processing unit to correspond to a particular selected bin of the plurality of bins. The method further includes encapsulating, by the router, the particular packet with a deterministic path header associated with a particular equal-cost multipath route corresponding to the particular selected bin and transmitting, by the router, the particular packet within the data center via the particular equal-cost multipath route.

According to one or more additional embodiments of the disclosure, another method includes determining, by a processing unit in a data center, one or more source port values associated with each of a plurality of bins of a router within the data center, wherein each bin corresponds to an equal-cost multipath route from the router within the data center; selecting, by the processing unit, a particular equal-cost multipath route from the router within the data center on which a particular packet is to be transmitted and a particular selected bin of the plurality of bins that corresponds to the particular equal-cost multipath route; generating, by the processing unit, the particular packet with a source port corresponding to one or more particular source port values associated with the particular selected bin; and transmitting, by the processing unit, the particular packet to the router to cause the router to transmit the particular packet within the data center via the particular equal-cost multipath route by encapsulating the particular packet with a deterministic path header associated with the particular equal-cost multipath route corresponding to the particular selected bin.

According to one or more further embodiments of the disclosure, a system, comprises: a data center; a graphics processing unit deployed in the data center; and a top-of-rack router deployed in the data center and communicatively coupled to the graphics processing unit, wherein the graphics processing unit is configured to: determine one or more source port values associated with each of a plurality of bins of the top-of-rack router within the data center, wherein each bin corresponds to an equal-cost multipath route from the top-of-rack router within the data center; select a particular equal-cost multipath route from the top-of-rack router within the data center on which a particular packet is to be transmitted and a particular selected bin of the plurality of bins that corresponds to the particular equal-cost multipath route; generate the particular packet with a source port corresponding to one or more particular source port values associated with the particular selected bin; and transmit the particular packet to the top-of-rack router to cause the top-of-rack router to transmit the particular packet within the data center via the particular equal-cost multipath route by encapsulating the particular packet with a deterministic path header associated with the particular equal-cost multipath route corresponding to the particular selected bin.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

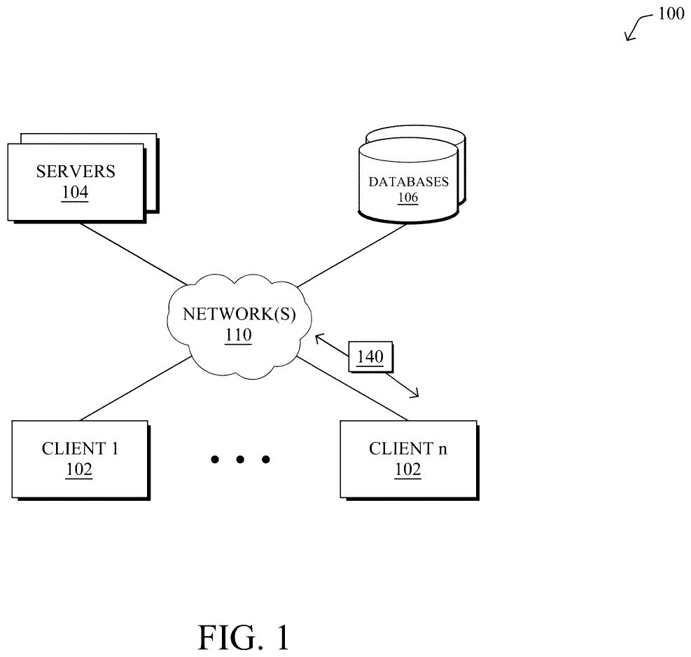

FIG. 1 is a schematic block diagram of an example simplified computing system (e.g., 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system, and that the view shown herein is for simplicity. As would also be appreciated, computing system may include any number of local networks, data centers, cloud environments, devices/nodes, servers, etc. Also, those skilled in the art will further understand that while the network is shown in a certain orientation, the computing system is merely an example illustration that is not meant to limit the disclosure.

For instance, smart object networks, such as sensor networks, in particular, are a specific type of network (e.g., 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

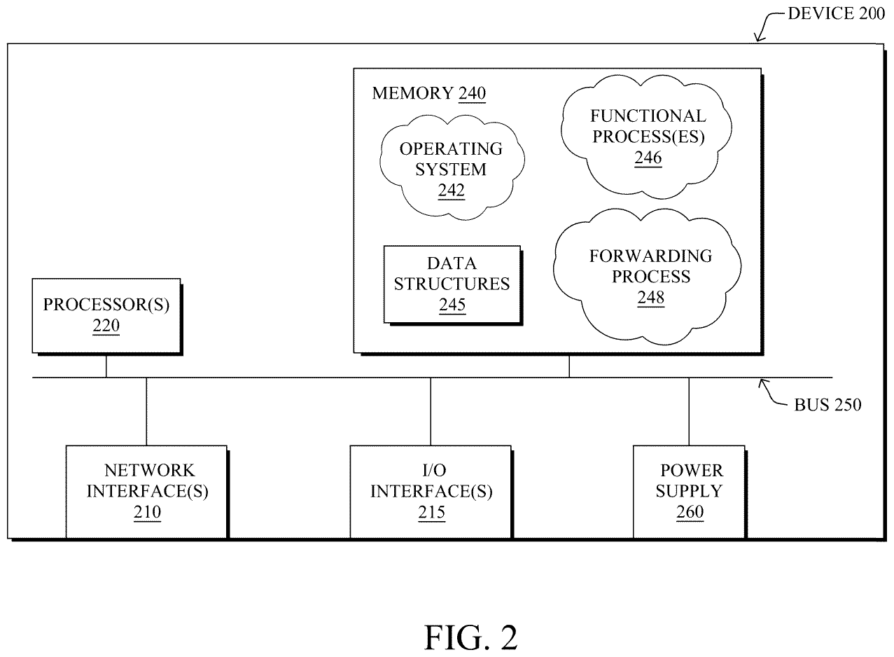

FIG. 2 is a schematic block diagram of an example node/device (e.g., an apparatus) that may be used with one or more implementations described herein, e.g., as any of the nodes or devices shown in FIG. 1 above or described in further detail below. The device may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a deterministic data center forwarding in artificial intelligence (AI) training clusters process, or “forwarding process” for brevity (process 248), as described herein, each of which may alternatively be located within individual network interfaces.

Notably, one or more functional processes 246, when executed by processor(s) 220, cause each device (e.g., 200) to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

For instance, one or more functional processes 246 may include computer executable instructions executed by the processor(s) 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, the one or more functional processes 246 may consist solely of providing mechanisms necessary for source routing techniques. That is, for source routing, other devices in the network can tell the less capable devices exactly where to send the packets, and the less capable devices simply forward the packets as directed.

In various implementations, as detailed further below, one or more functional processes 246 and/or forwarding process (process 248) may include computer executable instructions that, when executed by processor(s) 220, cause device to perform the techniques described herein. To do so, in some implementations, one or more functional processes 246 and/or process 248 may utilize machine learning. In general, machine learning is concerned with the design and the development of techniques that take as input empirical data (such as network statistics and performance indicators) and recognize complex patterns in these data.

For instance, in various implementations, one or more functional processes 246 and/or process 248 may employ one or more supervised, unsupervised, or semi-supervised machine learning models. Generally, supervised learning entails the use of a training set of data that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### Deterministic Data Center Forwarding in AI Training Clusters

As noted above, current approaches to reconciling the timing, bandwidth, and other discrepancies between traditional data center (DC) networks and AI training clusters may encounter issues when network conditions change abruptly (e.g., in the case of link flapping, etc.), which can cause widespread traffic rerouting and introduce new challenges in traffic management and debuggability.

Moreover, these approaches lack a mechanism that allows for deterministic path selection through the network fabric while retaining the advantages of equal-cost multipath (ECMP). This limitation is exacerbated by the absence of direct control by graphics processing units (GPUs) over traffic routing, despite GPUs being the most informed components regarding real-time performance within the training cluster.

To address these and other challenges, implementations herein provide solutions that not only ensure efficient traffic routing within AI training clusters but also empower GPUs with the capability to dynamically influence traffic paths based on real-time performance metrics. As discussed in more detail herein, such a solution must navigate the delicate balance between deterministic path selection and the flexibility of ECMP, thereby optimizing network utilization, reducing tail-latency, and ultimately enhancing the efficiency of AI training tasks.

The techniques herein therefore provide systems and methodologies that utilize transformative solutions that redefine traffic management within data centers. As mentioned above, traditional network approaches like DSF and DLB fall short in providing deterministic routing and GPU control over network paths, leading to performance bottlenecks and increased tail-latency. In contrast, implementations herein enhance top-of-rack (ToR) router functionalities and IPv6 Segment Routing with micro-segment identifier (uSID) lists to partition the source port range into bins aligned with ECMP paths, allowing for deterministic packet flow and immediate adaptation to network conditions.

By empowering GPUs to control traffic steering through dynamic source port selection, implementations herein provide a significant leap forward in network optimization. Further, implementations herein ensure a deterministic path selection that is resilient to topology changes, simplify traffic engineering, and drastically reduce tail-latency. These and other features of the present disclosure not only enhance the efficiency of AI training tasks but also establish a new benchmark for network traffic management in the face of the rapidly growing demands of AI computational systems.

As described herein, implementations of the present disclosure introduce a mechanism that empowers GPUs within AI training clusters to take direct control over network traffic routing, ensuring both determinism and dynamic adaptability in traffic management. This solution hinges on the strategic use of the ToR router's functionality paired with an intelligent GPU-driven traffic steering approach. The mechanism is outlined as follows.

In some implementations, the ToR router is enhanced with new functionality that divides the entire source port range, consisting of 65,535 ports (assuming the standard range for TCP/UDP ports), into several distinct bins. The exact number of bins corresponds to the number of ECMP paths available in the Clos topology (or other topology) of the data center.

Each bin is explicitly tied to a strict traffic engineering policy employing IPv6 segment routing with an uSID list. The uSID list is effectively a sequence of explicit instructions, indicating the interfaces that a packet should traverse at each hop throughout the network, represented by a sequence of micro-segment instructions (e.g., uA, uDT4, uDT6, uDT46, etc. instructions).

Specifically, according to one or more embodiments of the disclosure as described in detail below, a method includes associating, by a router, each bin of a plurality of bins with one or more source port values, wherein each bin corresponds to an equal-cost multipath route from the router within a data center and receiving, by the router, a particular packet from a processing unit in the data center, the particular packet having a source port as selected by the processing unit to correspond to a particular selected bin of the plurality of bins. The method further includes encapsulating, by the router, the particular packet with a deterministic path header associated with a particular equal-cost multipath route corresponding to the particular selected bin and transmitting, by the router, the particular packet within the data center via the particular equal-cost multipath route.

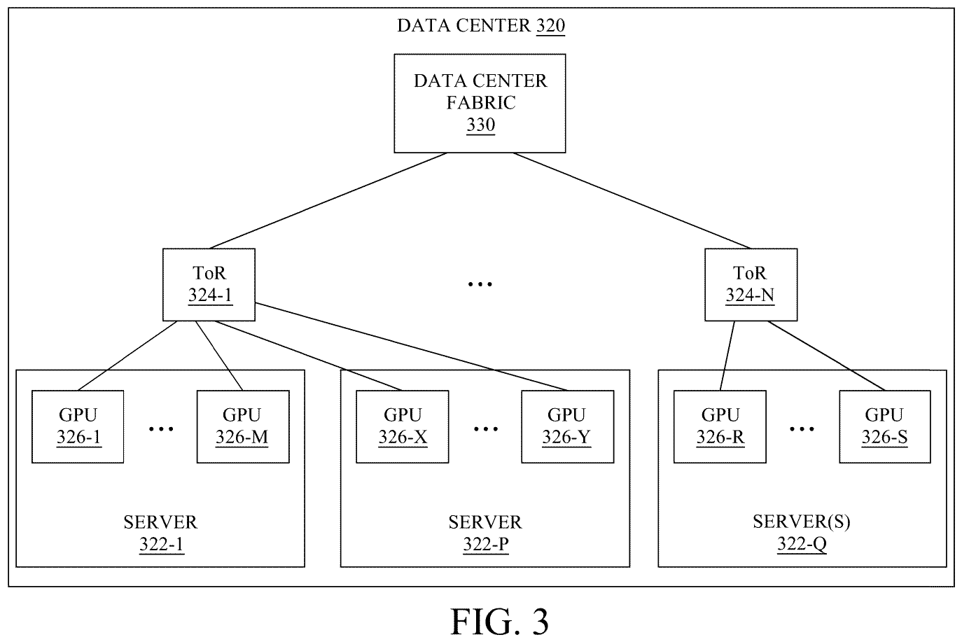

Operationally, FIG. 3 illustrates an example data center in accordance with the disclosure. As shown in FIG. 3, the data center 320 includes a first server 322-1 through an P^{th} server 322-P which are coupled to a first top-of-rack (ToR) router 324-1, as well as a plurality of servers 322-Q, which are coupled to an N^{th} ToR 324-N. Although two boxes representing servers are shown connected to the router 324-1 and one box representing servers is shown connect to the N^{th} ToR 324-N, it will be understood that each ToR can be coupled to multiple servers. As shown in FIG. 3, each of the servers can include a plurality of graphics processing units. That is, the first server 322-1 can include a first GPU 326-1 through an M^{th} GPU 326-M, the P^{th} server 322-P can include an X^{th} GPU 326-X through an Y^{th} GPU 326-Y, and the plurality of servers 322-Q can include an R^{th} GPU 326-R through an S^{th} GPU 326-S. Further, each of the GPUs can be coupled to one of the ToRs.

The ToRs 324 can be connected to a data center fabric 330. In some implementations, the data center fabric 330 can include various fabric switches, planes (e.g., spine planes), etc. that are not shown so as to not obfuscate the drawing layout. It will, however, be appreciated that such additional components that are typically deployed in a data center, such as the data center 320, can be present to facilitate implementations of the present disclosure.

As will be appreciated, the connection between the ToR routers and the GPUs can be ECMP, although implementations are not so limited. Further, it will be appreciated that the quantity of components illustrated in FIG. 3 is merely illustrative and greater or fewer components than illustrated in FIG. 3 may be included in the data center 320. For example, there may be hundreds or even thousands of GPUs provided in the data center 320, with a corresponding quantity of ToRs 324, leaf switches, and/or spine planes to accommodate the traffic generated from the provided quantity of GPUs.

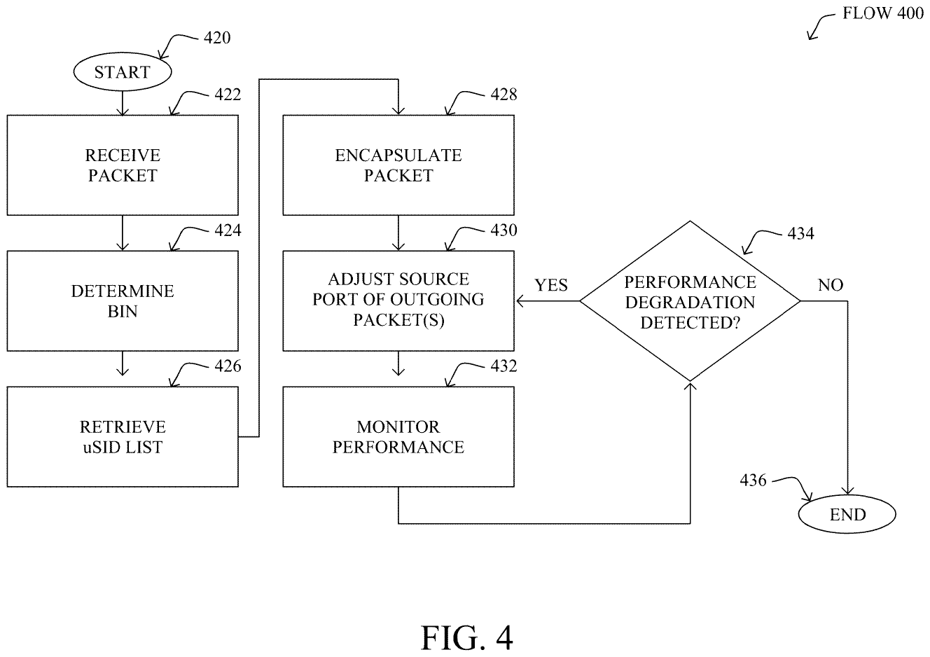

FIG. 4 illustrates an example flow for deterministic data center forwarding in artificial intelligence (AI) training clusters. As shown in FIG. 4, the flow (e.g., 400) may start at operation 420. The flow continues to operation 422 where a packet is received by, for example, a port of a ToR router. Upon receiving a packet, at operation 424, the ToR router can examine the user datagram protocol (UDP) source port to determine the corresponding bin. In some implementations, this classification can be based on pre-defined ranges of source ports allocated to each bin.

Once the appropriate bin is identified, at operation 426, the router can retrieve an associated uSID list. At operation 428, the packet is then encapsulated with an additional IPv6 header. In some implementations, the destination address (IPv6 DA) can contain uSID-based traffic engineering instructions. It is noted that this encapsulation can enable the enforcement of a deterministic path across the network without the need for a segment routing header (SRH), since up to six interfaces can be encoded within a uSID list, which is more than sufficient for AI data center fabric requirements.

At operation 430, the source ports of outgoing packets can be adjusted. In some implementations, the GPUs, being the source of outbound traffic and most aware of their real-time performance metrics, can assume the role of traffic controllers. By adjusting the source port (e.g., the Layer 4 source port) of outgoing packets, GPUs can influence which bin—and by extension, which deterministic path—a packet should follow. Further, at operation 432, the GPU(s) can monitor performance of the system in which the traffic is flowing. For example, if, at operation 434, a GPU detects performance degradation, the GPU can react swiftly by altering the UDP source port, prompting the ToR router to reroute the traffic through a different, and potentially less congested, network path. If there is no performance degradation detected, the flow can terminate at operation 436.

It is noted that, in FIG. 4, operation 422, operation 424, operation 426, and operation 428 can be performed by a top-of-rack router such as the ToRs illustrated in FIG. 3, while operation 430, operation 432, and operation 434 can be performed by a server, such as server 104 illustrated in FIG. 1.

In accordance with the disclosure, by leveraging the entropy of the source port selection, GPUs can gain additional control over the network paths that the data traffic takes, allowing real-time adaptability based on performance of the system (e.g., network). In addition, the techniques disclosed herein provide for deterministic network pathing, which can ensure that each packet follows a pre-determined path through the network. Changes in the topology, such as link failures or additions, therefore, may not result in unpredictable traffic redistribution, thus maintaining stability and predictability in traffic flow. Further, this feature can allow for avoidance of a need to perform any traffic reordering at the egress Top-of-Rack. Finally, by providing a means to circumvent congestion and performance bottlenecks dynamically, aspects of the present disclosure can reduce tail-latency and improve the overall efficiency of AI training tasks in comparison to some approaches.

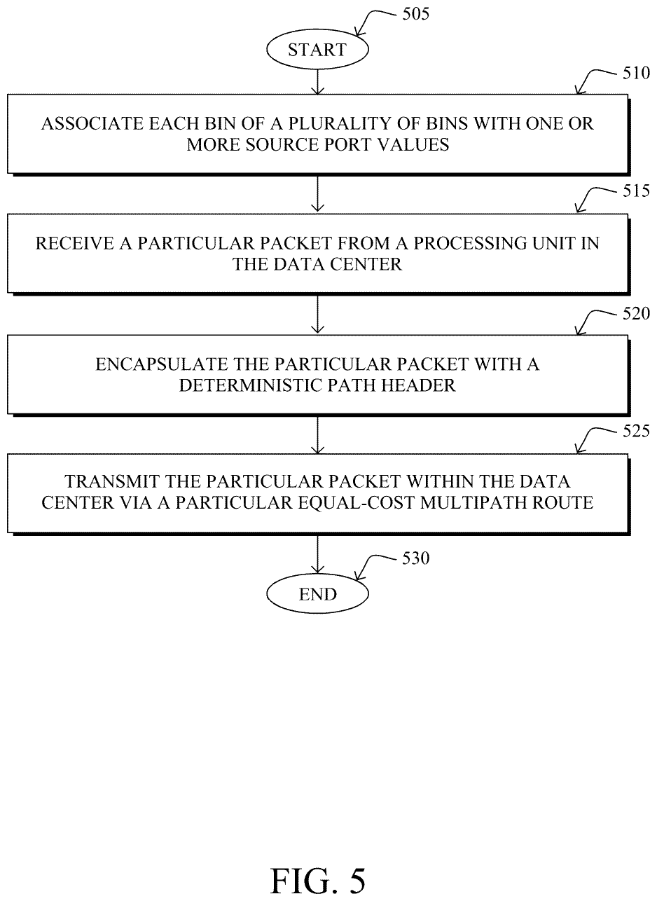

FIG. 5 illustrates an example simplified procedure for deterministic data center forwarding in artificial intelligence (AI) training clusters in accordance with one or more embodiments described herein, particularly from the perspective of a device, such as a ToR router and/or GPU. For example, a non-generic, specifically configured device (e.g., device, an apparatus) may perform procedure 500 by executing stored instructions (e.g., process 248). The procedure 500 may start at step 505, and continues to step 510, where, as described in greater detail above, a router associates each bin of a plurality of bins with one or more source port values, wherein each bin corresponds to an equal-cost multipath (ECMP) route from the router within a data center. In some implementations, the router can be a top-of-rack router. Further, in some implementations, the data center can have a Clos topology.

In some implementations, the one or more source port values can include a range or ranges of source port values. For example, if there are ten ECMPs and 64,000 source port values, ten bins (each bin corresponding to an ECMP path) can be associated with the source port values such that source port values 0 -6400 (e.g., a range of source port values) are associated to a first bin and, hence, a first ECMP path, source port values 6,401-12,800 are associated to a second bin and, hence, a second ECMP path, and so on and so forth.

Procedure 500 may continue to step 510 where, as described in greater detail above, the router receives a particular packet from a processing unit in the data center, the particular packet having a source port as selected by the processing unit to correspond to a particular selected bin of the plurality of bins. In some implementations, the processing unit can be a graphics processing unit (GPU). In addition to, or in the alternative, in some implementations, the source port can be a user datagram protocol (UDP) port.

Procedure 500 may continue to step 515 where, as described in greater detail above, the router encapsulates the particular packet with a deterministic path header associated with a particular equal-cost multipath route corresponding to the particular selected bin. The deterministic path header can be based on a micro segment identifier (uSID), as discussed above.

Procedure 500 may continue to step 520 where, as described in greater detail above, the router transmits the particular packet within the data center via the particular equal-cost multipath route. As discussed above, the particular packet can be part of data traffic associated with training an artificial intelligence model.

In some implementations, each bin of the plurality of bins is associated with a traffic engineering policy. In such implementations, the procedure 500 can further include employing segment routing in accordance with the traffic engineering policy using a micro segment identifier list encapsulated in a destination address associated with the particular packet.

In some implementations, the procedure 500 can further include determining, by the processing unit, that a degradation in performance associated with traffic on the particular equal-cost multipath route; altering the source port as selected by the processing unit to a different source port that corresponds to a different particular selected bin of the plurality of bins; encapsulating, by the router, a subsequent packet with a new deterministic path header associated with a different particular equal-cost multipath route corresponding to the different particular selected bin; and transmitting, by the router, the subsequent packet within the data center via the different particular equal-cost multipath route.

Procedure 500 may end at step 530.

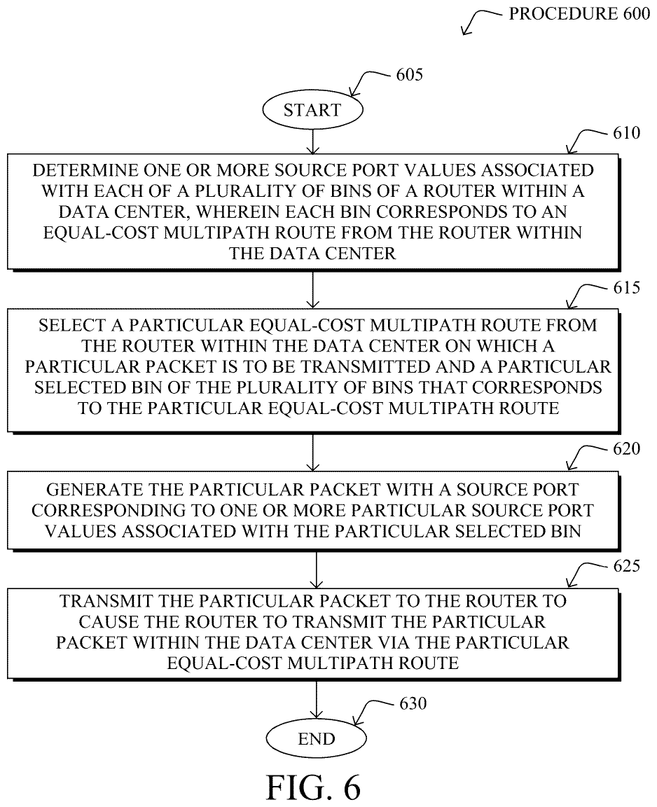

FIG. 6 illustrates another example procedure for deterministic data center forwarding in artificial intelligence (AI) training clusters in accordance with one or more embodiments described herein, particularly from the perspective of a device, such as a ToR router and/or GPU. For example, a non-generic, specifically configured device (e.g., device, an apparatus) may perform procedure 600 by executing stored instructions (e.g., process 248). The procedure 600 may start at step 605, and continues to step 610, where, as described in greater detail above a processing unit in a data center determines one or more source port values associated with each of a plurality of bins of a router within the data center, wherein each bin corresponds to an equal-cost multipath route from the router within the data center.

In some implementations, the processing unit can be a graphics processing unit (GPU). Further, in some implementations, the router can be a top-of-rack router. In addition, as discussed above, the data center can have a Clos topology. In addition, as discussed above, in some implementations, the one or more source port values can comprise a range or ranges of source port values.

Procedure 600 may continue to step 615 where, as described in greater detail above, the processing unit selects a particular equal-cost multipath route from the router within the data center on which a particular packet is to be transmitted and a particular selected bin of the plurality of bins that corresponds to the particular equal-cost multipath route.

Procedure 600 may continue to step 620 where, as described in greater detail above, the processing unit generates the particular packet with a source port corresponding to one or more particular source port values associated with the particular selected bin.

Procedure 600 may continue to step 625 where, as described in greater detail above, the processing unit transmits the particular packet to the router to cause the router to transmit the particular packet within the data center via the particular equal-cost multipath route by encapsulating the particular packet with a deterministic path header associated with the particular equal-cost multipath route corresponding to the particular selected bin. As discussed above, the particular packet can be part of data traffic associated with training an artificial intelligence model. In some implementations, the deterministic path header can be based on a micro segment identifier (uSID).

In some implementations, each bin of the plurality of bins can be associated with a traffic engineering policy. In such implementations, the procedure 600 can further include employing segment routing in accordance with the traffic engineering policy using a micro segment identifier list encapsulated in a destination address associated with the particular packet.

In some implementations, the procedure 600 can further include determining, by the processing unit, that a degradation in performance associated with traffic on the particular equal-cost multipath route; altering the source port as selected by the processing unit to a different source port that corresponds to a different particular selected bin of the plurality of bins; encapsulating, by the router, a subsequent packet with a new deterministic path header associated with a different particular equal-cost multipath route corresponding to the different particular selected bin; and transmitting, by the router, the subsequent packet within the data center via the different particular equal-cost multipath route.

Procedure 600 may end at step 630.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise a data center; a graphics processing unit deployed in the data center; and a top-of-rack router deployed in the data center and communicatively coupled to the graphics processing unit. In such implementations, the graphics processing unit is configured to: determine one or more source port values associated with each of a plurality of bins of the top-of-rack router within the data center, wherein each bin corresponds to an equal-cost multipath route from the top-of-rack router within the data center; select a particular equal-cost multipath route from the top-of-rack router within the data center on which a particular packet is to be transmitted and a particular selected bin of the plurality of bins that corresponds to the particular equal-cost multipath route; generate the particular packet with a source port corresponding to one or more particular source port values associated with the particular selected bin; and transmit, the particular packet to the top-of-rack router to cause the top-of-rack router to transmit the particular packet within the data center via the particular equal-cost multipath route by encapsulating the particular packet with a deterministic path header associated with the particular equal-cost multipath route corresponding to the particular selected bin.

The techniques described herein, therefore, provide for deterministic data center forwarding in AI training clusters. As discussed above, implementations herein enhanced ToR router functionalities and IPv6 Segment Routing with uSID lists to partition the source port range into bins aligned with ECMP paths, allowing for deterministic packet flow and immediate adaptation to network conditions. This can allow for improved network optimization in comparison to some approaches via ensuring a deterministic path selection that is resilient to topology changes, simplifies traffic engineering, and reduces tail-latency. These and other features of the present disclosure not only enhance the efficiency of AI training tasks but also establish a new benchmark for network traffic management in the face of the rapidly growing demands of AI computational systems.

Illustratively, the techniques described herein may be performed by hardware, software, and/or firmware, (e.g., an “apparatus”) such as in accordance with the forwarding process (e.g., a deterministic data center forwarding in artificial intelligence (AI) training clusters), process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
associating, by a router, each bin of a plurality of bins with one or more source port values, wherein each bin corresponds to an equal-cost multipath route from the router within a data center;
receiving, by the router, a particular packet from a processing unit in the data center, the particular packet having a source port as selected by the processing unit to correspond to a particular selected bin of the plurality of bins;
encapsulating, by the router, the particular packet with a deterministic path header associated with a particular equal-cost multipath route corresponding to the particular selected bin; and
transmitting, by the router, the particular packet within the data center via the particular equal-cost multipath route.

2. The method of claim 1, wherein the processing unit comprises a graphics processing unit.

3. The method of claim 1, wherein the source port comprises a user datagram protocol port.

4. The method of claim 1, wherein the router is a top-of-rack router.

5. The method of claim 1, wherein each bin of the plurality of bins is associated with a traffic engineering policy and the method further comprises:
employing segment routing in accordance with the traffic engineering policy using a micro segment identifier list encapsulated in a destination address associated with the particular packet.

6. The method of claim 1, wherein the particular packet is part of data traffic associated with training an artificial intelligence model.

7. The method of claim 1, wherein the data center has a Clos topology.

8. The method of claim 1, wherein the deterministic path header is based on a micro segment identifier.

9. The method of claim 1, wherein the one or more source port values comprise a range or ranges of source port values.

10. The method of claim 1, wherein the processing unit determines a degradation in performance associated with traffic on the particular equal-cost multipath route and alters the source port as selected by the processing unit to a different source port that corresponds to a different particular selected bin of the plurality of bins, the method further comprising:
encapsulating, by the router, a subsequent packet with a new deterministic path header associated with a different particular equal-cost multipath route corresponding to the different particular selected bin; and
transmitting, by the router, the subsequent packet within the data center via the different particular equal-cost multipath route.

11. A method, comprising:
determining, by a processing unit in a data center, one or more source port values associated with each of a plurality of bins of a router within the data center, wherein each bin corresponds to an equal-cost multipath route from the router within the data center;
selecting, by the processing unit, a particular equal-cost multipath route from the router within the data center on which a particular packet is to be transmitted and a particular selected bin of the plurality of bins that corresponds to the particular equal-cost multipath route;
generating, by the processing unit, the particular packet with a source port corresponding to one or more particular source port values associated with the particular selected bin; and
transmitting, by the processing unit, the particular packet to the router to cause the router to transmit the particular packet within the data center via the particular equal-cost multipath route by encapsulating the particular packet with a deterministic path header associated with the particular equal-cost multipath route corresponding to the particular selected bin.

12. The method of claim 11, wherein the processing unit comprises a graphics processing unit.

13. The method of claim 11, wherein the router is a top-of-rack router.

14. The method of claim 11, wherein each bin of the plurality of bins is associated with a traffic engineering policy and the method further comprises:
employing segment routing in accordance with the traffic engineering policy using a micro segment identifier list encapsulated in a destination address associated with the particular packet.

15. The method of claim 11, wherein the particular packet is part of data traffic associated with training an artificial intelligence model.

16. The method of claim 11, wherein the data center has a Clos topology.

17. The method of claim 11, wherein the deterministic path header is based on a micro segment identifier.

18. The method of claim 11, wherein the one or more source port values comprise a range or ranges of source port values.

19. The method of claim 11, further comprising:
determining, by the processing unit, a degradation in performance associated with traffic on the particular equal-cost multipath route; and
altering the source port as selected by the processing unit to a different source port that corresponds to a different particular selected bin of the plurality of bins;
wherein the router is caused to encapsulate a subsequent packet with a new deterministic path header associated with a different particular equal-cost multipath route corresponding to the different particular selected bin and transmit the subsequent packet within the data center via the different particular equal-cost multipath route.

20. A system, comprising:
a data center;
a graphics processing unit deployed in the data center; and
a top-of-rack router deployed in the data center and communicatively coupled to the graphics processing unit, wherein the graphics processing unit is configured to:
determine one or more source port values associated with each of a plurality of bins of the top-of-rack router within the data center, wherein each bin corresponds to an equal-cost multipath route from the top-of-rack router within the data center;
select a particular equal-cost multipath route from the top-of-rack router within the data center on which a particular packet is to be transmitted and a particular selected bin of the plurality of bins that corresponds to the particular equal-cost multipath route;
generate the particular packet with a source port corresponding to one or more particular source port values associated with the particular selected bin; and
transmit the particular packet to the top-of-rack router to cause the top-of-rack router to transmit the particular packet within the data center via the particular equal-cost multipath route by encapsulating the particular packet with a deterministic path header associated with the particular equal-cost multipath route corresponding to the particular selected bin.
